(19) United States
(12) Patent Application Publication
(10) Pub. No.: US 2013/0017133 A1
(43) Pub. Date: Jan. 17, 2013

(54) SYSTEMS AND METHODS FOR FLUID SAMPLE PROCESSING

(71) Applicants: Liuming Yu, Leawood, KS (US); Barry Sample, Seneca, SC (US); Brian Lanzrath, Olathe, KS (US)

(72) Inventors: Liuming Yu, Leawood, KS (US); Barry Sample, Seneca, SC (US); Brian Lanzrath, Olathe, KS (US)

(21) Appl. No.: 13/511,948

(22) PCT Filed: Nov. 19, 2010
(86) PCT No.: PCT/US10/57459

§ 371 Date: Sep. 28, 2012

Related U.S. Application Data
(60) Provisional application No. 61/264,107, filed on Nov. 24, 2009.

(51) Int. Cl. B01L 3/00

(52) U.S. Cl. 422/550; 422/549

(57) ABSTRACT

A system for processing a fluid sample includes a tube and a piston. The tube has an open end and a closed end, and a volume defined therebetween. The volume is further defined by an interior surface of the tube. The tube is designed to receive a collection media holding the fluid sample. The piston has a first side and a second side, and is designed to be inserted into the tube via the open end of the tube. The piston is further designed to be translatable within the tube, and to compress the collection media between the closed end of the tube and the first side of the piston such that at least a portion of the fluid sample is removed from the collection media and driven to the second side of the piston.

### FIELD OF THE INVENTION

The invention relates generally to the field of systems and methods for fluid sample processing. More specifically the present disclosure relates to systems and methods for storage of a fluid sample, and removal of the fluid sample from a collection media.

### BACKGROUND OF THE INVENTION

Collection pads, cotton swabs, artificial sponges, absorbent papers, or other collection media may be used to collect a sample of fluids from a variety of sources including, for example biological fluids. The fluid sample is absorbed and temporarily held by the collection media. Chemicals or additional fluids may be added to the fluid sample, the collection media, in order to preserve or alter the fluid sample for storage, preparation, or testing. For example, a collection pad may be treated with a hypertonic solution for purposes of collecting and preserving saliva. For testing, the fluid sample is typically removed (e.g., extracted, eluted, separated, etc.) from the collection media. The present invention provides improved devices and methods for extracting a sample fluid from collection media.

### SUMMARY OF THE INVENTION

The invention provides a system for processing and extracting a fluid sample from collection media. The system includes a tube and a piston. The tube has an open end and a closed end, and a volume defined therebetween. The volume is further defined by an interior surface of the tube. The tube is designed to receive a collection media holding the fluid sample. The piston has a first side and a second side, and is designed to be inserted into the tube via the open end of the tube. The piston is further designed to be translatable within the tube, and to compress the collection media between the closed end of the tube and the first side of the piston such that at least a portion of the fluid sample is removed from the collection media and driven to the second side of the piston. In one configuration, the piston has one or more grooves on the longitudinal surface (i.e., the surface juxtaposed to the sidewalls of the tube), such that the extracted fluid flows through the grooves from the first side of the piston to the second side of the piston, thereby bringing the first side and the second side of the piston into fluid communication contact. Alternatively or in addition to the grooves, the piston contains one or more conduits which facilitate fluid communication contact between the first side and the second side of the piston. In another configuration, the piston does not form a fluid-impervious seal with the side walls of the tube in order that fluid may flow from the first side of the piston to the second side of the piston. In this way, the piston has an outer diameter smaller than the smallest inner diameter of the tube. Thus, the space between the longitudinal piston surface and the tube inner wall provides a fluid-conductive space. In all of the foregoing embodiments, the total dead volume of the fluid conductive spaces (e.g., the grooves and conduits) should be less than the volume of fluid expected to be captured by the collection media.

In one embodiment, the tube does not have a cap. In another embodiment, the tube is fitted with a removable cap. Optionally, the cap is capable of sealing the open and/or the cap is tethered to the tube. In one configuration, the piston is releasably coupled to the cap. In this configuration, the collection media is loaded into the tube and the tube is sealed with the cap and releasable piston. Upon actuation, the piston is released from the cap into the tube to compress the collection media and extract the fluid. Optionally, the system further comprises a locking system designed to lock the piston in a position compressing the collection media.

Yet another embodiment of the invention relates to a system for processing a fluid sample. The system includes a tube, a piston, and a locking feature. The tube has a first end and a second end, where the first end includes an opening. The tube is designed to receive a collection media holding the fluid sample. The piston is insertable through the opening, and has a first side and a second side. The piston is designed to be translatable within the tube, and to compress the collection media between the second end of the tube and the first side of the piston such that at least a portion of the fluid sample is removed from the collection media. A locking feature is designed to lock the piston in a position compressing the collection media.

Alternative exemplary embodiments relate to other features and combinations of features as may be generally recited in the claims.

### BRIEF DESCRIPTION OF THE FIGURES

FIG. 1 is a side view of a system for processing a fluid sample in a first configuration according to an exemplary embodiment of the invention.

FIG. 2 is a side view of the system of FIG. 1 in a second configuration.

FIG. 3 is a sectional view of a piston according to an exemplary embodiment of the invention.

FIG. 4 is a sectional view of a piston according to another exemplary embodiment of the invention.

FIG. 5 is a sectional view of a portion of a system for processing a fluid sample in a first configuration according to another exemplary embodiment of the invention.

FIG. 6 is a sectional view of the system for processing a fluid sample of FIG. 5 in a second configuration.

FIG. 7 is a sectional view of the system for processing a fluid sample of FIG. 5 in a third configuration.

FIG. 8 is a sectional view of the system for processing a fluid sample of FIG. 5 in a fourth configuration.

FIG. 9 is a sectional view of the system for processing a fluid sample of FIG. 5 in a fifth configuration.

FIG. 10 is a perspective view of a system for processing a fluid sample in a first configuration according to yet another exemplary embodiment of the invention.

FIG. 11 is a perspective view of the system for processing a fluid sample of FIG. 10 in a second configuration.

FIG. 12 is a perspective view of a cap and a piston according to an exemplary embodiment of the invention.

FIG. 13 is a sectional view of the cap and the piston of FIG. 12.

FIG. 14 is a diagram of a sequence of steps for processing a fluid sample according to an exemplary embodiment of the invention.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

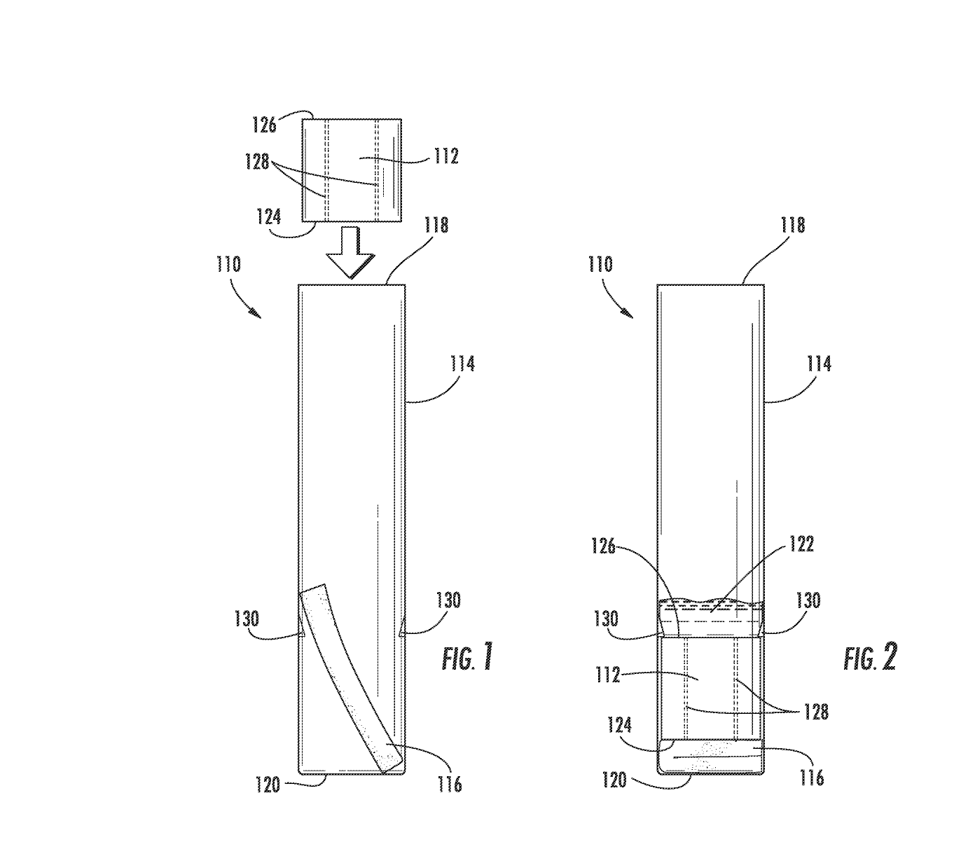

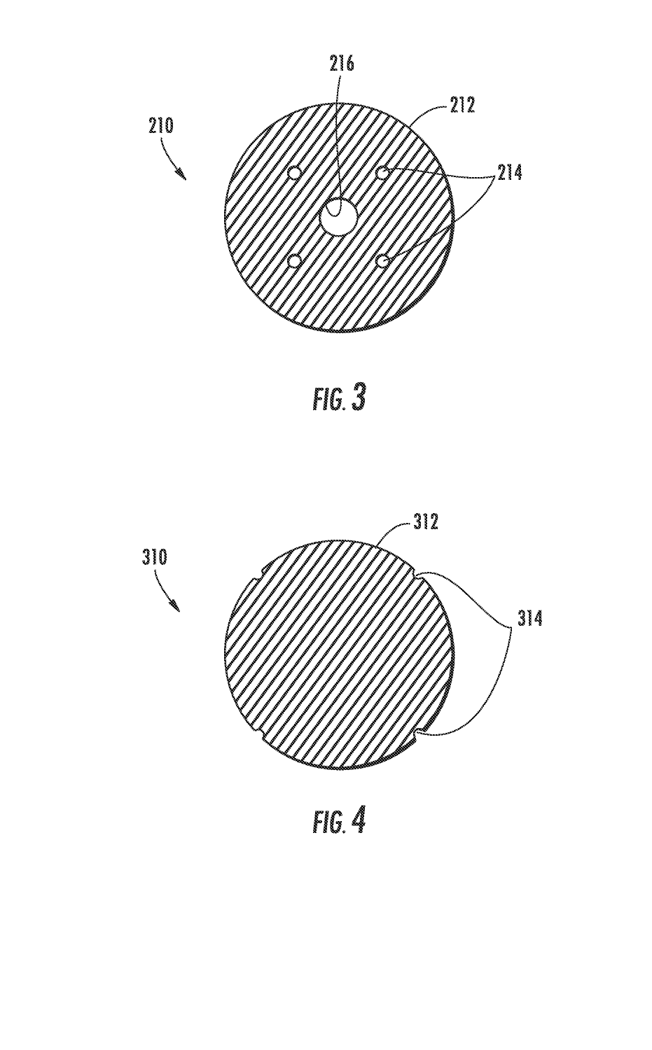

Referring to FIG. 1, a system 110 for processing a fluid sample includes a piston 112 (e.g., plunger) and a tube 114 (e.g., test tube, sample tube, vial, barrel, etc.). The tube 114 and piston 112 may be used for storing, handling, holding, separating, preparing, or otherwise processing a fluid sample (e.g., fluid sample 122 as shown in FIG. 2), which may be gathered and held in a collection media 116 that is placed in the tube 114. In some embodiments, the tube 114 includes a first end 118 (e.g., open end, top end) and a second end 120 (e.g., closed end, bottom end), which may include a curved or flat bottom surface. According to an exemplary embodiment, the piston 112 is shaped to match the interior of the tube 114 such that a cross section of the piston 112 substantially fills a cross section of the interior of the tube 114. However, the piston 112 is further designed to be translatable (e.g., slide, roll, etc.) within the tube 114, and may be forced, pulled, or otherwise moved through the tube 114 to compress the collection media 116.

Still referring to FIG. 1, the piston 112 includes a first side 124 and a second side 126. A portion of the piston 112, such as the first side 124 of the piston 112, is generally shaped to match the cross-section of the tube 114 (e.g., square tube and piston, oval tube and piston, etc.). While the piston 112 in FIG. 1 is cylindrical, in other embodiments, pistons for a cylindrical tube may be spherical or dome-shaped, such as a spherical piston used to compress collection media 116 placed inside a tube. Although the first side 124 and the second side 126 of the piston are illustrated as flat, any convenient surface shape may be used and the two sides need not have the same shape. For example, the piston surfaces may be concave or convex and further contain protruding or recessed features. In one specific example, the first side 124 has a convex shape that approximately matches the shape of a round-bottom tube and the second side 126 is convex, providing a well to facilitate fluid extraction using a pipette. Optionally, either or both sides of the piston 112 may be patterned (i.e., not smooth). One useful pattern is a checkerboard or hashed pattern.

In one configuration, the piston 112 in FIG. 1 further includes channels extending between the first side 124 and the second side 126 of the piston 112. The channels in FIG. 1 are shown as conduits 128 that are straight and unobstructed, extending through the piston 112. In other embodiments, channels may be curved, include check valves, or extend along an exterior of the piston (see, e.g., grooves 314 as shown in FIG. 4). The channels extending between the first and second sides 124, 126 of the piston 112 allow fluid (e.g., air, fluid sample, etc.) to pass the piston 112 as the piston 112 translates toward the second end 120 of the tube 114.

According to an exemplary embodiment, the piston 112 is metal, ceramic, plastic, composite, or formed from another material, preferably a weighted material (e.g., density greater than 850 kg/m³, preferably greater than 1000 kg/m³). In some embodiments, the piston 112 has a mass exceeding 750 mg, preferably exceeding 1000 mg. In certain embodiments, the piston 112 includes a low friction coating (e.g., providing a static friction coefficient less than 1.0), such as a coating of polypropylene, Teflon, etc. In some embodiments, the piston 112 is at least approximately 15 mm in length (e.g., 20 mm) and has a diameter of about 16 mm, but is slightly narrower than the diameter of the tube 114. In other embodiments, the diameter of the piston 112 is slightly larger than the diameter of the tube 114, but is at least partially formed from a flexible material that compresses to allow the piston 112 to translate within the tube 114 (e.g., piston with rubber shell).

In some embodiments, the tube 114 is formed from polypropylene or another thermoplastic polymer, metal, glass, ceramic, or other impermeable materials. In some embodiments, the tube 114 is approximately 80 mm in length and has about a 16 mm diameter (e.g., 14 or 20 mm diameter), but the dimensions of the tube 114 vary depending upon a particular embodiment. In other embodiments a tube may include an opening or port in the first and the second ends of the tube, or the second end may include a frangible portion configured to be removed to form an opening in the second end.

Referring to FIGS. 1-2, during use of the system 110, the collection media 116 may be placed into the tube 114. Subsequently, the piston 112 may be inserted into the first end 118 of the tube 114. Once inserted, the piston 112 may be moved (forced, pulled, pushed, etc.) to translate through the tube 114 to compress the collection media against the second end 120 of the tube 114. Compressing the collection media 116 removes at least a portion of the fluid sample 122 (see FIG. 2) from the collection media 116 by squeezing the fluid sample 122 out of the collection media 116. The fluid sample 122 then passes through the conduits 128 or around the piston 112 (i.e., between the piston and the interior surface of the tube 114), and is driven from the first side 124 of the piston 112 to the second side 126 of the piston 112. Once on the second side 126 of the piston 112, the fluid sample 122 may be extracted from the tube 114, such as via a pipette.

According to some exemplary embodiments, after being inserted into the tube 114, the piston 112 is configured to be moved from the first end 118 toward the second end 120 of the tube 114 by accelerating the mass of the piston 112. The mass of the piston 112 is accelerated via a process of centrifugation. For example, the tube 114 may be spun in a centrifuge having a 17.5 cm radius at a rate of 3000 rpm (approximately 1750 g) for about 15 minutes. In other embodiments, acceleration of gravity is sufficient to move the piston 112 to compress the collection media 116 (e.g., lead piston) without centrifugation. In still other embodiments the piston 112 may be pushed or pulled through the tube 114, such as with a plunger shaft, magnets, etc.

The system 110 optionally includes a locking feature. In one example, the locking feature includes a protrusion 130 extending from an interior surface of the tube 114. According to an exemplary embodiment, the protrusion 130 is positioned a distance from the second end 120 of the tube 114 that is slightly greater than the length of the piston 112. The piston 112 passes the protrusion 130 when the piston 112 is being moved toward the second end 120 of the tube 114 to compress the collection media 116, such as during centrifugation. When centrifugation is stopped, the piston 112 is held in a position compressing the collection media 116, preventing the collection media 116 from expanding to reabsorb the fluid sample 122. In some embodiments, the locking feature includes several protrusions arranged at different distances from the second end 120 of the tube 114, providing a one-way ratcheting of the piston 112 as the piston 112 translates through the tube 114. In certain embodiments, the locking feature includes a protrusion in the form of a lip that extends fully around the interior surface of the tube. In other embodiments, the locking feature includes only a single protrusion, such as a wedge, bump, or ramp. In still other embodiments, the piston may be otherwise locked into a position compressing the collection media (e.g., using magnets, suction held by check valves in the conduits 128, etc.). In an alternative locking design, the tube 114 is tapered, having a larger cross-sectional diameter at the open end 118, and narrowing toward the closed end 120. In this design, the piston 112 is also tapered having a larger cross-sectional diameter at the second side 126 than the first side 124 and further designed such that the cross-sectional diameter of the first side is the same as the cross-sectional diameter of the tapered tube at the point in the tube where the piston 112 is desired to be locked. In practice, the force of application of the piston (e.g., centrifugation) causes the piston 112 to become lodged within the tapered tube 114 at a vertical position sufficient to extract fluid from the collection media 116.

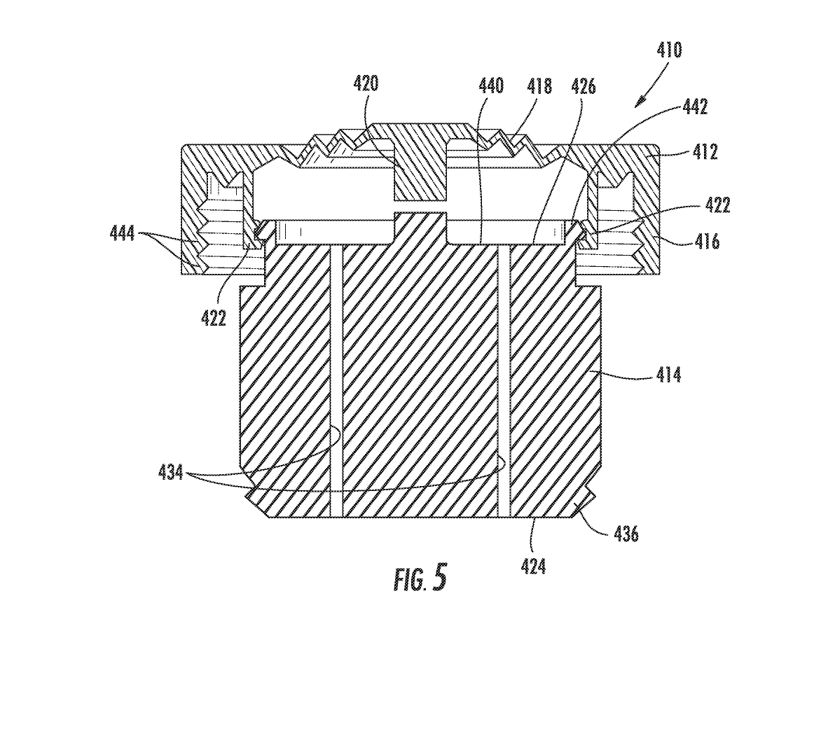

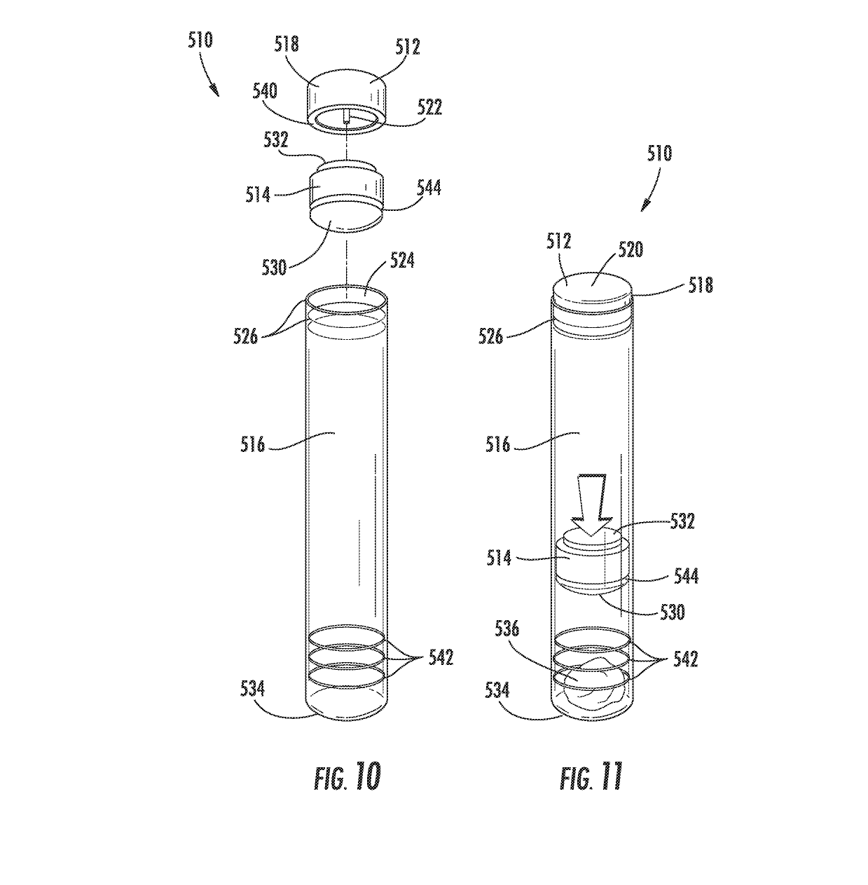

Referring to FIGS. 3-4, pistons 210, 310 are shown according to alternative exemplary embodiments. The pistons 210, 310 include peripheries 212, 312 that are substantially circular and are configured to allow the pistons 210, 310 to fit into cylindrical tubes (see, e.g., tube 516 as shown in FIG. 10). The piston 210 includes channels in the form of conduits 214 extending through the piston 210, and also includes a center aperture 216 used as a guide hole. The center aperture 216 may fit a guide rod of a cap (see, e.g., rod 522 and cap 512 as shown in FIG. 10), which may be used to releasably fasten the piston 210 to the cap. In some embodiments, the center aperture 216 does not extend completely through the piston 210. Contrary to the piston 210, the piston 310 includes channels in the form of grooves 314 extending along the periphery 312 of the piston 310. In one embodiment, the piston 112 contains both conduits 214 and grooves 314.

Referring to FIG. 3, the conduits 214 of the piston 210 have a circular cross-section with a diameter greater than 0.01 mm and less than 2 mm, such as about 0.25 mm. However, in other embodiments, conduits 214 have diameters less than 0.01 mm or greater than 2 mm. In some embodiments, the conduits 214 are reinforced, such as by a narrow metal tube embedded in a ceramic body of the piston 210. In other embodiments, the conduits do not have circular cross-sections. Preferably, the conduits 214 are designed to be narrow enough to prevent a large volume of liquid from being trapped in the conduits 214, which may be difficult to collect with a pipette. Conversely, the conduits 214 are designed to be wide enough to allow for a sufficient flow of fluid (e.g., air and liquid) to pass through the conduits, especially if the piston 210 fits tightly in the tube, which may prevent or restrict fluid from passing between the piston and the interior surface of the tube (i.e., around the piston).

Referring now to FIG. 4, the grooves 314 of the piston 310 extend in a straight line between first and second sides of the piston 310. According to an exemplary embodiment, the grooves 314 are less than 2 mm deep (i.e., from the periphery toward the center of the piston 310), preferably less than 0.5 mm deep, such as about 0.25 mm. In some embodiments a single groove is used, while in other embodiments several grooves are used to provide channels for fluid to pass through as the piston 310 translates in a tube. In some embodiments, the grooves 314 are positioned on opposite sides of the periphery 312 of the piston 310 in order to counterbalance each other. In still other embodiments, a combination of conduits internal to a piston are used with grooves around an exterior of the piston. In other embodiments no grooves or conduits are used, and the periphery of the piston or the interior surface of the tube is shaped to provide channels or to otherwise allow access for fluid to pass.

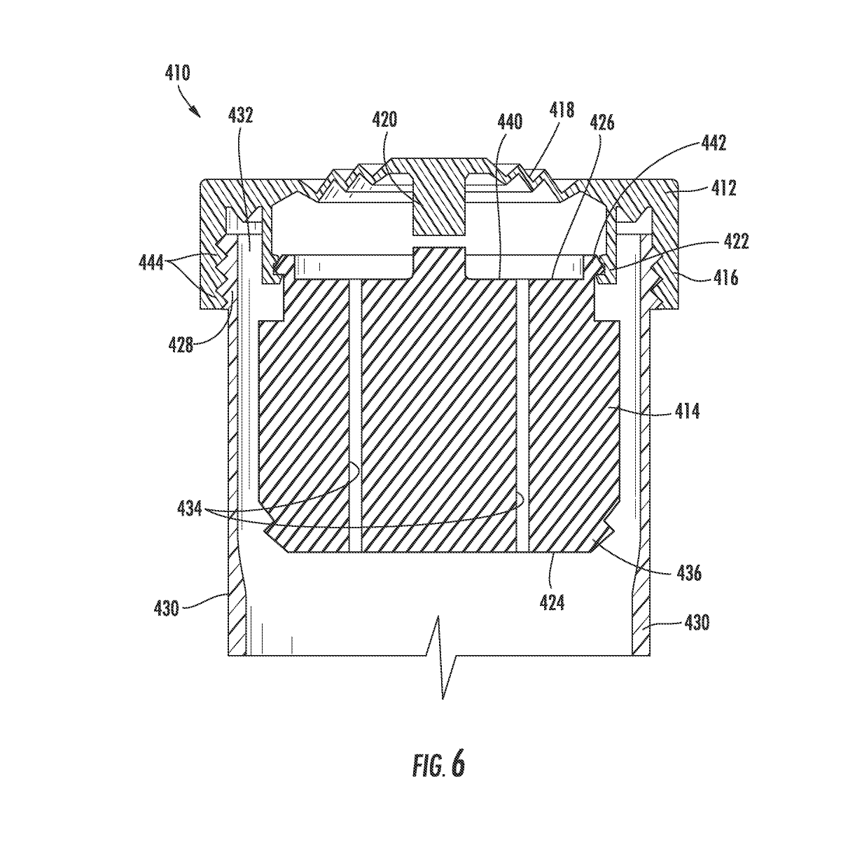

Referring the FIGS. 5-9, a system 410 for processing a fluid sample includes a cap 412 and a piston 414. The cap 412 includes a skirt 416, a flexible portion 418, and an attachment structure for releasably coupling the piston 414 to the cap 412. The piston 414 has a first side 424 and a second side 426, and includes conduits 434 extending therethrough. The piston 414 further includes a flange 436, collection areas 440, and an attachment structure for coupling to the cap 412. While the system 410 includes the cap 412 and piston 414, in some embodiments, the system 410 also includes a tube 430 (see also system 110 as shown in FIGS. 1-2), such as a sample tube, a test tube, or another container. Other systems include different components or combinations of components (e.g., piston and tube).

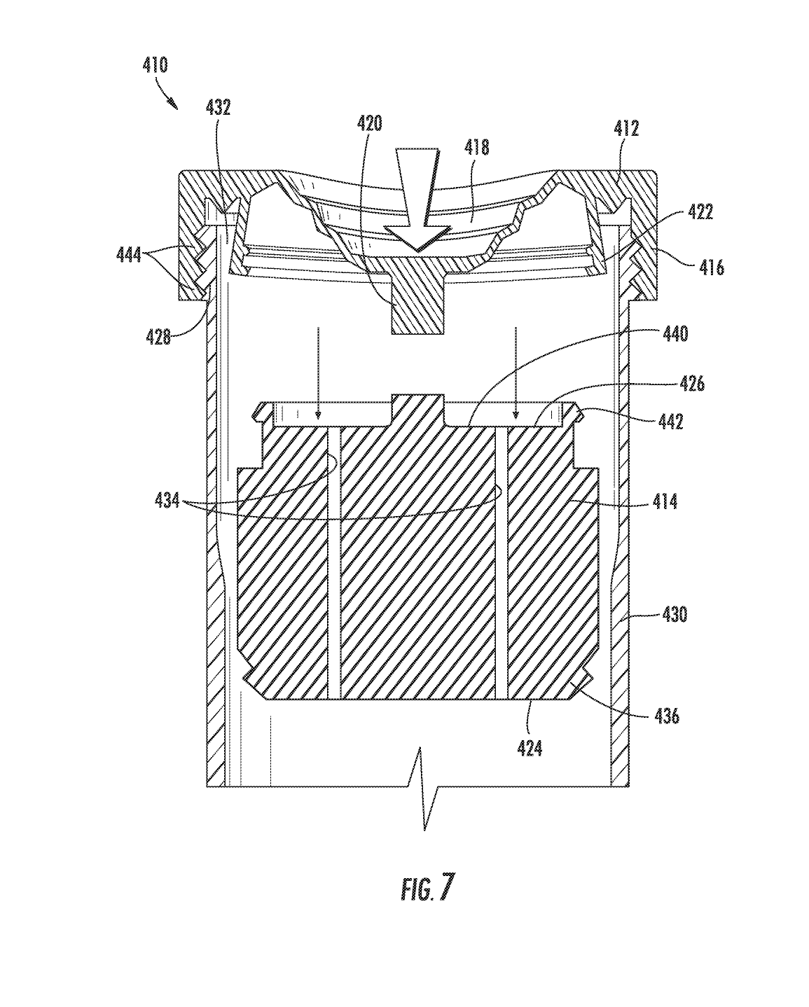

Referring now to FIGS. 5-6, the cap 412 is designed to be fastened to the tube 430 (see FIG. 6). The cap 412 includes the skirt 416, which includes threading 444 and serves as a female connector. The threading 444 is designed to fasten (e.g., screw) the cap 412 to a threaded male connector 428 on an end 432 of the tube 430. According to an exemplary embodiment, the skirt 416 of the cap 412 may be screwed onto the tube 430, forming a seal to close the tube 430. Whereas FIG. 5 shows the cap 412 and piston 414 separate from a tube, FIG. 6 shows the cap 412 screwed onto the top of the tube 430.

In another embodiment, a cap for a test tube includes a “snap-on” feature in the form of a skirt with an inwardly directed flange proximate to a bottom of the skirt. When the cap is “snapped” onto the test tube, the flange is moved over a lip around the top of the test tube. As such, the flange and the lip interlock to fasten the cap to the top of the test tube. In other embodiments, a cap (e.g., stopper) may be fastened to the tube 430 via a pressure fit (see, e.g., cap 512 as shown in FIG. 10), or another fastener.

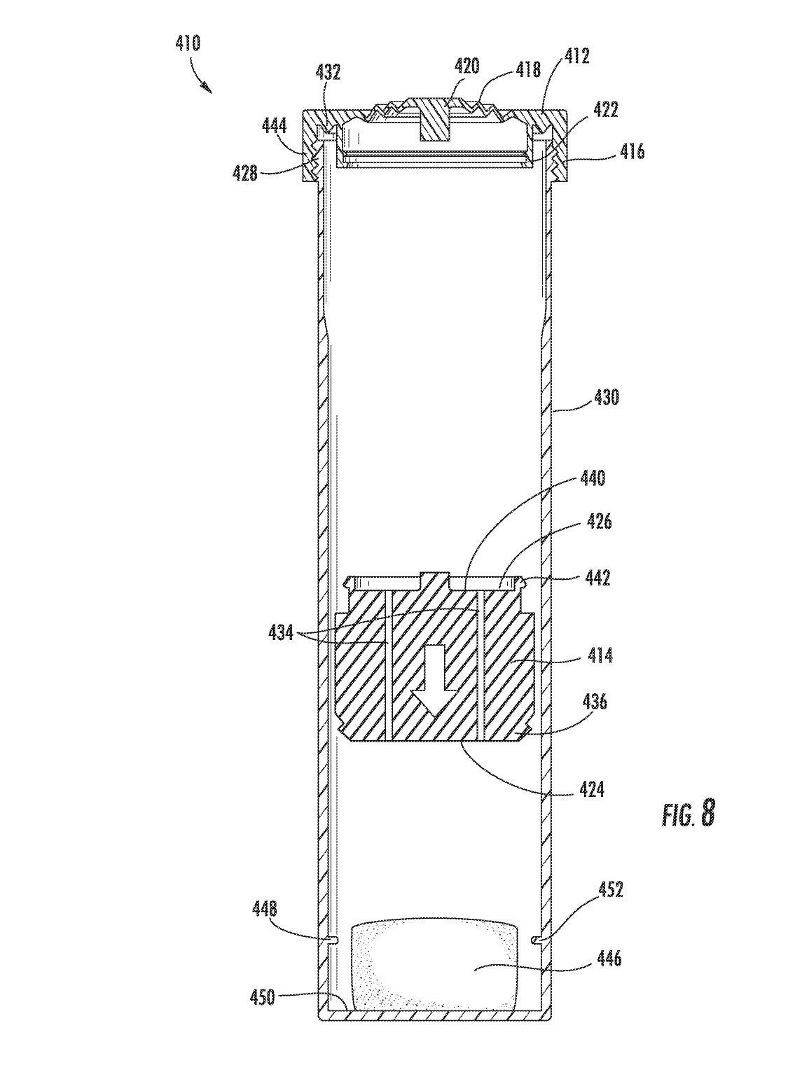

Referring to FIGS. 6-8, the attachment structure of the cap 412 and piston 414 includes hooks 442 and 422. During assembly of the system 410, the first end 424 of the piston 414 may be inserted into the underside of the cap 412, such that the hooks 442 of the piston interlock with the hooks 422 of the cap 412. In some embodiments, a rod 420 or other surface may be coupled to the flexible portion 418 of the cap 412, and positioned above and adjacent to the piston 414. As shown in FIGS. 5-9, the rod 420 may be used for unfastening the piston 414 from the cap 412, such as for processing of a fluid sample (e.g., to facilitate elution of liquid stored in a collection sample held in the tube). If a user presses the flexible portion 418 of the cap 412, then the rod 420 of the cap will be pressed against the piston 414, pushing the piston 414 away from the hooks 422 of the cap 412. Further, the hooks 422 will bend outward as shown in FIG. 7, which unfastens the piston 414 from the cap 412. FIG. 8 shows the cap 412 returned to its original shape when the user has stopped pressing the cap 412, with the piston 414 remaining detached from the cap 412. In some embodiments, detachment of the piston 414 from the cap 412 may occur automatically by forces generated during centrifugation.

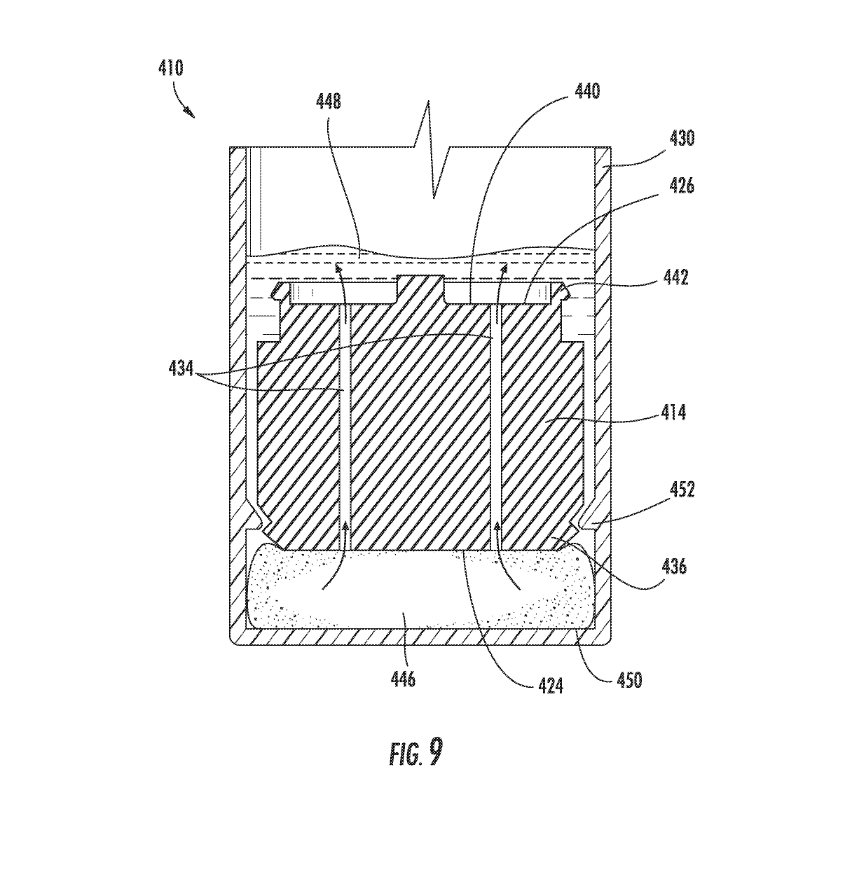

Referring to FIG. 9, centrifugation or other methods may be used to move the piston 414 through the tube 430. Preferably the piston 414 is moved with sufficient force to compress a collection media 446 such that a fluid sample 448 held in the collection media 446 is removed from the collection media 446 and is accessible following centrifugation. During use of the system 410, the fluid sample 448 is transferred from the collection media 446, through and/or around the piston 414. Collection areas 440 are formed on the second side 426 of the piston 414 at an end of the conduits 434. The fluid sample 448 may flow through the conduits 434 and pool in or on the collection areas 440, designed to facilitate removal of the fluid sample 448.

According to an exemplary embodiment illustrated in FIGS. 8-9, the system 410 includes a locking feature. The flange 436 of the piston 414 is designed to serve as a part of the locking feature. The tube 430 includes a protrusion in the form of a lip 452 extending around at least a portion of the tube 430, proximate to a bottom end 450 of the tube 430. During operation, the flange 436 of the piston 414 is moved over the lip 452 of the tube 430. For example, forces during centrifugation are sufficient to push the flange 436 of the piston 414 over the lip 452. Following centrifugation, when the forces are diminished, surfaces on the piston 414 and the tube 430 interlock, such as the flange 436 and the lip 452, limiting the ability of the collection media 446 to expand and recollect the fluid sample 448. In other embodiments, a protrusion is designed to interlock with a top surface of a piston (see generally FIG. 2), as opposed to the flange 436.

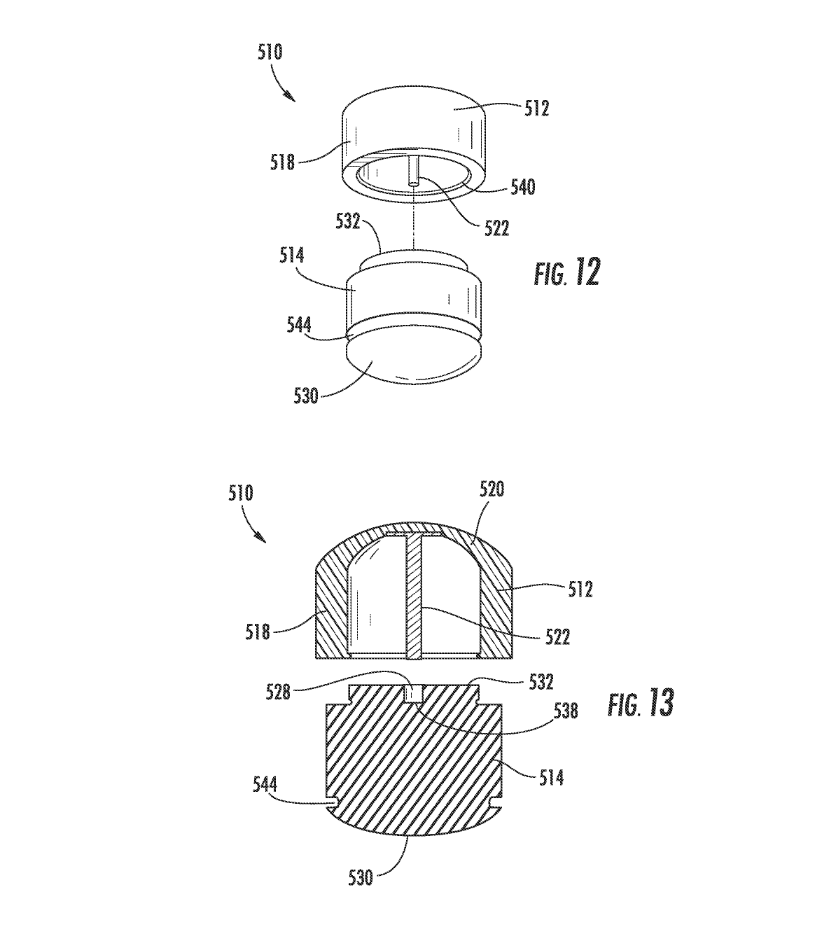

Referring now to FIGS. 10-13, a system 510 for processing a fluid sample includes a cap 512, a piston 514, and a tube 516. The cap 512 includes a skirt 518, a flexible portion 520 on top of the cap 512, and a rod 522 extending below the flexible portion 520, through the skirt 518. The exterior of the skirt 518 is sized to fit within an opening 524 on a first end 526 of the tube 516. When inserted, the exterior of the skirt 518 is compressed by the first end 526 of the tube 516, forming a pressure fit to cover and seal the first end 526. The piston 514 is generally cylindrical in shape and has a first side 530 and a second side 532. The rod 522 of the cap 512 is designed to couple the cap 512 to the piston 514 such that the rod 522 fits within an aperture 528 on a second side of the piston 514 (see also center aperture 216 as shown in FIG. 4). As such, the cap 512 and the piston 514 are configured to be releasably coupled. The first side 530 of the piston 514 is rounded to match a second end 534 of the tube 516.

According to an exemplary embodiment, a fluid sample may be collected on a collection media 536 and placed within the tube 516 (see FIG. 11). The cap 512 may be used to seal the tube 516. The piston 514 may be coupled to the cap 512, and inserted into the first end 526 of the tube 516 while the cap 512 is being fastened to cover the first end 526 of the tube 516. The tube 516 (now sealed) may then be kept in storage, transported, or immediately processed. When ready to process the fluid sample, pressing the flexible portion 520 of the cap 512 pushes the rod 522 into the aperture 528 on the piston 514 (see FIG. 13). The rod 522, in turn, pushes a bottom surface 538 of the aperture 528 and moves the piston 514 away from the cap 512. Once out of the cap 512, the first side 530 of the piston 514 is limited by an underside 540 of the cap 512 from moving back into the cap 512 (unless forced). As such, the system 510 is designed to allow the piston 514 to be unfastened from the cap 512 while the tube 516 remains sealed.

The piston 514 is sized to be translatable within the tube 516, and is further sized such that a small amount of space (i.e., gap) extends between the piston 514 and at least a portion of the interior surface of the tube 516. Once inserted into the tube 516, the piston 514 may be moved toward the second end 534 of the tube 516 to compress the collection media 536 in the tube 516. As the piston 514 moves through the tube 516, fluids in the tube 516 travel around the piston 514, between the piston 514 and the tube 516. According to an exemplary embodiment, the tube 516 is configured to be spun in a centrifuge, where forces acting on the piston 514 move the piston 514 so that the first side 530 of the piston 514 compresses the collection media 536 against the second end 534 of the tube 516. Fluid sample stored in the collection media 536 is removed from the collection media 536, passes the piston 514, and pools on the second side 532 of the piston 514.

A locking feature allows for locking of the piston 514 in a position in which the collection media 536 remains compressed. As shown in FIGS. 10-11, the locking feature includes a series of protrusions in the form of lips 542 extending around an interior of the tube 516, and a flange 544 on the piston 514. The lips 542 are arranged such that the piston 514 ratchets toward the second end 534, such as during centrifugation. The piston is moved over some or all of the lips 542 such that at least one of the lips 542 and the flange 544 interlock when the piston is no longer forced to translate through the tube 516, such as when centrifugation has ended. The collection media 536 is compressed between the piston 514 and the second end 534 of the tube 516. Following compression of the collection media 536, the fluid sample may be removed from the tube 516 for testing or analysis.

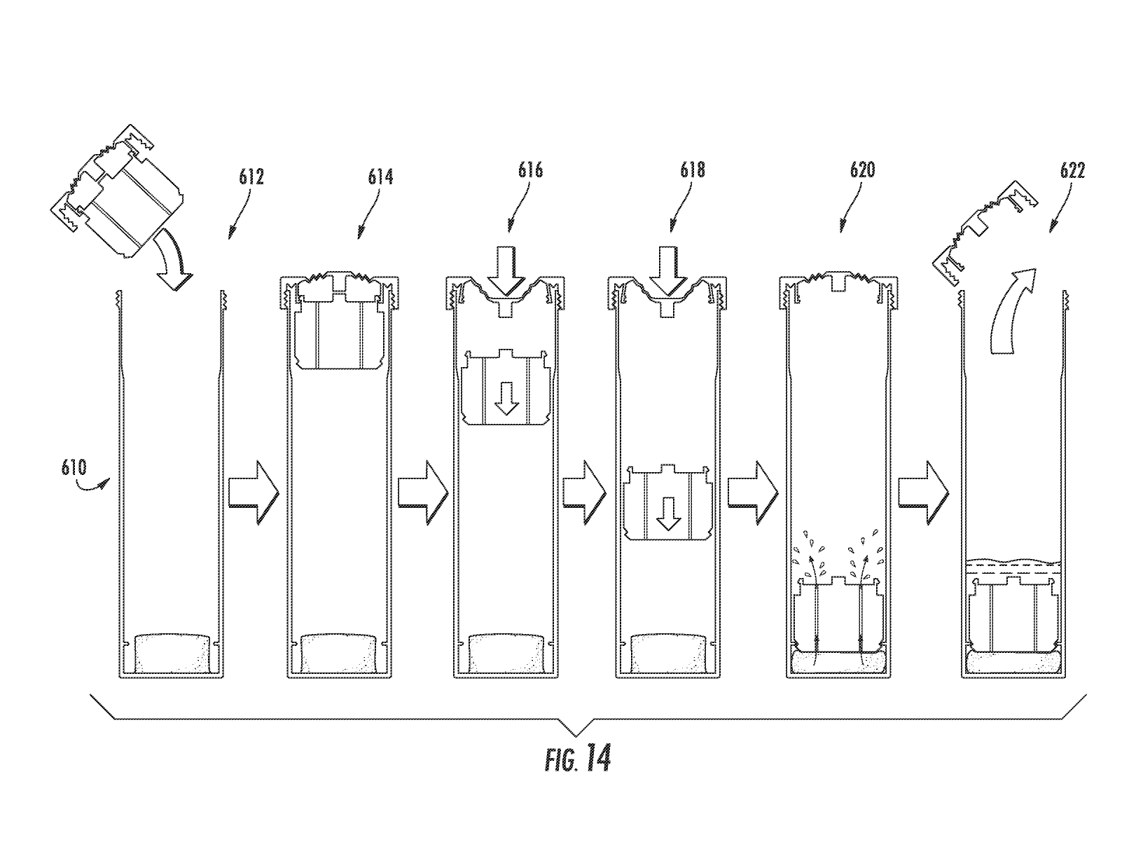

Referring now to FIG. 14, a method 610 for using a system for processing a fluid sample includes several steps. One step 612 includes providing a cap, a piston, and a tube (see generally FIGS. 1-13). The providing step 612 may further include placing a collection media holding a fluid sample in the tube. Another step 614 includes closing or sealing the tube with the cap. The closing step 614 may further include inserting the piston into an open side of the tube. In some embodiments, the closing step 614 includes screwing the cap onto the tube. While in other embodiments, the closing step 614 includes “snapping” or pressure fitting the cap and the tube together. In some embodiments, an additional step includes storing the fluid sample, such as via refrigeration for at least an hour. In other embodiments, an additional step includes transporting the fluid sample from a collection location to a testing laboratory.

Yet another step 616 includes releasing the piston. The releasing step 616 further includes releasing the piston while the tube remains sealed by the cap, where removal of the cap is not required in order to release the piston. In some embodiments, the releasing step 616 includes pressing a flexible portion of the cap, such that pressing the flexible portion decouples hooks connecting the cap and the piston. In other embodiments, the releasing step 616 includes twisting, pulling, or otherwise manipulating the cap to release the piston. In still other embodiments, the releasing step 616 includes removing the cap from the tube, and inserting a piston into the tube.

Still referring to FIG. 14, a step 618 includes moving the piston through the tube. In some embodiments, the moving step 618 includes centrifugation, where the tube (and piston and cap) are spun in a centrifuge. In other embodiments, the moving step 618 includes manually pushing or pulling the piston through the tube (e.g., with a push rod, or magnets). In still other embodiments, the moving step 618 includes a combination of pushing the piston part of the way through the tube, and using centrifugation to move the piston the rest of the way through the tube, in order to sufficiently compress the collection media and release the fluid sample.

The moving step 618 may additionally include moving the piston into a locking feature. Another step 620 includes locking or otherwise securing the piston or collection media such that the collection media does not recapture the fluid sample that has been released from the collection media. In some embodiments, the locking step 620 occurs when portions of the tube and the piston interlock while the piston is compressing the collection media.

Yet another step 622 includes removing the fluid sample from the tube. In some embodiments, the removing step 622 includes use of a pipette or capillary tube to suction the fluid sample from a top side of the piston. In other embodiments, the removing step 622 includes pouring the fluid sample from the tube. In still other embodiments, the removing step 622 may include breaking or fracturing a portion of the tube, such as a frangible nipple thereon (not shown), to facilitate removal of the fluid sample. In some embodiments, the piston and tube may be reused by removing the piston from the tube; cleaning the piston, cap, and tube; and recoupling the piston and the cap.

According to an exemplary embodiment, a method for manufacturing a system for processing a fluid sample may include providing and assembling combinations of components for a system (e.g., systems 110, 410, 510 as shown in the FIGURES). Such methods for manufacturing (or for using) the system may include additional steps relating to the disclosure provided herein with regard to the FIGURES and various embodiments disclosed.

The construction and arrangements of the systems and methods of processing a fluid sample, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

1. A system for processing a fluid sample, comprising:
a tube configured to receive a collection media holding the fluid sample, the tube having an open end and a closed end, and a volume defined therebetween, the volume further defined by an interior surface of the tube; and
a piston having a first side, a second side, and at least one unobstructed conduit or groove therebetween, wherein the piston is configured to be inserted into the tube via the open end and is configured to be translatable within the tube,
wherein the piston is configured to compress the collection media between the closed end of the tube and the first side of the piston such that at least a portion of the fluid sample is removed from the collection media and driven through or around the piston to the second side of the piston by way of the conduit or groove.

2. A system according to claim 1, further comprising a locking feature configured to lock the piston in a position compressing the collection media.

3. A system according to claim 2, wherein the locking feature comprises a protrusion on the interior surface of the tube, the protrusion configured to interlock with a portion of the piston.

4. A system according to claim 3, wherein the protrusion comprises a lip extending at least partially around the interior surface of the tube, and the piston comprises a surface configured to receive the lip.

5. A system according to claim 1, wherein the piston further comprises a conduit extending between the first side and the second side of the piston.

6. A system according to claim 1, wherein the piston comprises a groove on an exterior surface of the piston sufficient to bring the first side and second side of the piston into fluid communication contact.

7. A system according to claim 1, wherein the piston comprises a conduit and a groove, wherein each of the conduit and the groove permit fluid communication between the first side and the second side of the piston.

8. A system for processing a fluid sample, comprising:
a tube configured to receive a collection media holding the fluid sample, the tube having a first end and a second end, wherein the first end includes an opening;
a cap configured to cover the opening; and
a piston insertable through the opening and releasably coupled to the cap, the piston having a first side, a second side, and at least one unobstructed conduit or groove therebetween, wherein the piston is configured to be translatable within the tube, and
wherein the piston is configured to compress the collection media between the second end of the tube and the first side of the piston such that at least a portion of the fluid sample is removed from the collection media.

9. A system according to claim 8, wherein the piston and the cap are configured to be decoupled while the cap is covering the opening of the first end of the tube.

10. A system according to claim 8, wherein the cap comprises a flexible portion, and wherein pressing the flexible portion decouples the piston and the cap.

11. A system according to claim 10, wherein the cap and the piston include interlocking flanges configured to hold the cap and the piston together, and wherein pressing the flexible portion releases the interlocking flanges.

12. A system according to claim 8, wherein the second end of the tube is closed, and wherein the at least a portion of the fluid sample is driven from the collection media to the second side of the piston when the piston is compressing the collection media.

13. A system according to claim 8, wherein the first end of the piston is substantially contoured to match the second end of the tube.

14. A system for processing a fluid sample, comprising:
a tube configured to receive a collection media holding the fluid sample, the tube having a first end and a second end, wherein the first end includes an opening;
a piston insertable through the opening, the piston having a first side, a second side, and at least one unobstructed conduit or groove therebetween,wherein the piston is configured to be translatable within the tube, and wherein the piston is configured to compress the collection media between the second end of the tube and the first side of the piston such that at least a portion of the fluid sample is removed from the collection media; and
a locking feature configured to lock the piston in a position compressing the collection media.

15. A system according to claim 14, wherein the locking feature comprises a protrusion on an interior surface of the tube, the protrusion configured to interlock with a portion of the piston.

16. A system according to claim 14, wherein the piston further includes a channel extending between the first side and the second side thereof

17. A system according to claim 16, wherein the channel is a conduit or a groove.

18. A system according to claim 14, further comprising a cap configured to fasten to the tube and to cover the opening of the first end, wherein the piston is releasably coupled to the cap such that the piston is configured to be inserted through the opening of the first end and remain coupled to the cap when the cap is fastened to the tube.

19. A system according to claim 18, wherein the cap and the piston include interlocking flanges configured to hold the cap and the piston together, and wherein pressing a flexible portion of the cap releases the interlocking flanges and decouples the cap and the piston.
